(19) United States
(12) Patent Application Publication
(10) Pub. No.: US 2026/0269696 A1
(43) Pub. Date: Sep. 10, 2026

(54) METHOD FOR MANUFACTURING ROTARY ELECTRIC MACHINE

(71) Applicant: MITSUBISHI GENERATOR CO., LTD, Kobe City, Hyogo (JP)

(72) Inventors: Yoshiki IWAMI, Chiyoda-ku, Tokyo (JP); Kenichi SAKODA, Chiyoda-ku, Tokyo (JP)

(73) Assignee: Mitsubishi Generator Co., Ltd., Kobe City, Hyogo (JP)

(21) Appl. No.: 19/167,833

(22) PCT Filed: Jun. 1, 2023
(86) PCT No.: PCT/JP2023/020408

§ 371 Date: Sep. 22, 2025

(51) Int. Cl. H02K 15/00; H02K 9/10

(52) U.S. Cl. CPC H02K 15/00; H02K 9/10

(57) ABSTRACT

When cooling the inside in the axial direction of at least one of a stator coil end portion and a phase ring, the relative ratio of the outside diameter of an axial flow fan to the outside diameter of an axial outer end portion of a holding ring is increased, and when the outside in the axial direction of at least one of the stator coil end portion and the phase ring is cooled, the relative ratio of the outside diameter of the axial flow fan to the outside diameter of the axial outer end portion of the holding ring is decreased.

### TECHNICAL FIELD

The present disclosure relates to a method for manufacturing a rotary electric machine.

### BACKGROUND ART

Conventionally, there has been a turbine generator in which cooling air from a cooler is introduced into the machine interior by a fan provided on a rotor shaft of the turbine generator, and the generator body is cooled.

### CITATION LIST

### Patent Document

Patent Document 1: Japanese Laid-Open Patent Publication No. 08-205473

### SUMMARY OF THE INVENTION

### Problem to Be Solved by the Invention

In the conventional technology, a flow path of cooling air flowing to a stator coil end portion or a phase ring of a rotary electric machine had not been controlled, and an increase in the air volume of the cooling air to a portion where electrical loss becomes large had not been considered.

The present disclosure has been made to solve the above problem, and an object of the present disclosure is to provide a method for manufacturing a rotary electric machine that enables control of a flow path of cooling air flowing to a stator coil end portion or a phase ring of the rotary electric machine, and increases a flow rate of the cooling air to a portion where electrical loss becomes large.

### Means to Solve the Problem

The method for manufacturing a rotary electric machine disclosed in the present disclosure is a method including:
a stator including a stator core, a stator coil provided in the stator core, and a stator coil end portion protruding from an axial end portion of the stator core;
a rotor including a rotor coil provided on a rotor shaft so as to face an inner peripheral portion of the stator core, and a holding ring that holds an axial end portion of the rotor coil;
an axial flow fan provided on an axial outer side of the holding ring on the rotor shaft; and
a phase ring provided on a radial outer side of the stator coil end portion and connected to the stator coil end portion; wherein
when cooling an axial inner side of at least one of the stator coil end portion and the phase ring, a relative ratio of an outer diameter of the axial flow fan to an outer diameter of an axial outer end portion of the holding ring is increased, and
when cooling an axial outer side of at least one of the stator coil end portion and the phase ring, the relative ratio is reduced.

### Effect of the Invention

According to the method for manufacturing the rotary electric machine disclosed in the present disclosure, a flow path of cooling air flowing to the stator coil end portion or the phase ring of the rotary electric machine can be controlled, and an air volume of the cooling air to a portion where electrical loss becomes large can be increased.

### BRIEF DESCRIPTION OF THE DRAWINGS

FIG. 1 is a partial cross-sectional view showing a schematic configuration of the rotary electric machine according to an embodiment of the present disclosure.

FIG. 2 FIGS. 2A and 2B are schematic views showing a connection relationship between the stator coil end portion and the phase ring.

FIG. 3 is a partial cross-sectional view showing a main flow of cooling air for the stator coil end portion and the phase ring.

FIG. 4 is a diagram explaining the cooling position of the stator coil end portion and the phase ring.

FIG. 5 is a partial cross-sectional view for explaining the method of manufacturing the rotary electric machine according to example 1.

FIG. 6 is a partial cross-sectional view for explaining the method of manufacturing the rotary electric machine according to example 1.

FIG. 7 FIGS. 7A and 7B are diagrams showing analyzed cooling air flows near the stator coil end portion and the phase ring when the outer diameter of the axial flow fan is relatively small and when it is relatively large.

FIG. 8 is a partial cross-sectional view for explaining the method of manufacturing the rotary electric machine according to example 2.

FIG. 9 is a partial cross-sectional view for explaining the method of manufacturing the rotary electric machine according to example 3.

### DESCRIPTION OF EMBODIMENTS

The present disclosure has an object of actively directing cooling air to a location where a temperature of a stator coil end portion or a phase ring becomes high, by controlling a flow path of cooling air in a rotary electric machine.

This is achieved by changing a relationship between an outer diameter of an axial flow fan mounted on a rotor shaft and an outer diameter of an axial outer end portion of a holding ring that holds an axial end portion of a rotor coil, a relationship of an axial position of the axial outer end portion of the holding ring, and a structure of the axial outer end portion of the holding ring.

Hereinafter, embodiments of the present disclosure will be described in detail.

### DESCRIPTION OF THE EMBODIMENT OF THE PRESENT DISCLOSURE

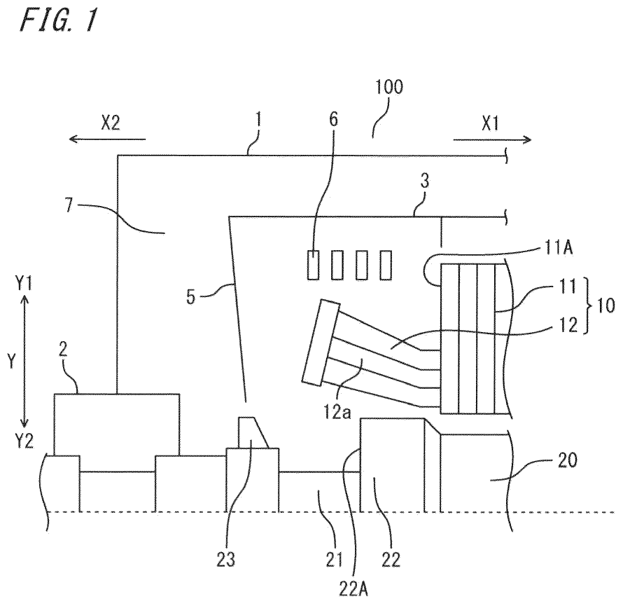

FIG. 1 is a partial cross-sectional view showing a schematic configuration of a rotary electric machine according to the embodiment of the present disclosure.

In FIG. 1, a rotary electric machine 100 includes a stator 10 and a rotor 20 disposed so as to face an inner peripheral portion of the stator 10, both provided in a casing 1.

In the following description, an axial inner side of the rotary electric machine 100 is referred to as X1, an axial outer side as X2, a radial outer side as Y1, and a radial inner side as Y2.

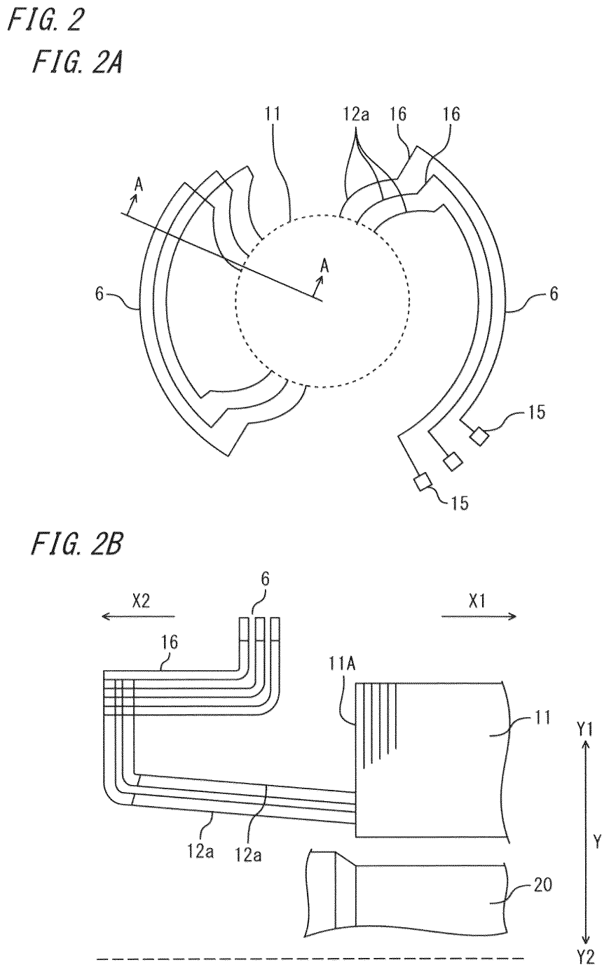

The stator 10 includes a stator core 11, a stator coil (not shown) accommodated in a slot of the stator core 11, and a stator coil end portion 12 composed of a plurality of stator coil ends 12a (see FIG. 2A below) protruding from an axial end 11A of the stator core 11.

The rotor 20 includes a rotor coil (not shown) provided on a rotor shaft 21, and a holding ring 22 that holds an axial end portion of the rotor coil (axial end of the rotor coil).

An axial flow fan 23 is attached to an axial outer side X2 of the holding ring 22 on the rotor shaft 21.

The rotor shaft 21 is rotatably supported by the casing 1 via a bearing portion 2.

The stator 10 is attached to a stator frame 3 that forms part of the casing 1. An end plate 5 is provided on the stator frame 3 facing the axial flow fan 23, and a ventilation path 7 for cooling air is formed.

On a radial outer side Y1 of the stator coil end portion 12, a phase ring 6 connected to a stator coil end 12a is disposed in a circumferential direction and an axial direction of the rotary electric machine 100.

FIGS. 2A and 2B are schematic diagrams showing a connection relationship between the stator coil end portion and the phase ring.

FIG. 2A is a side view of schematic diagram showing the connection relationship between the stator coil end portion and the phase ring from the axial outer side of the rotary electric machine 100. A stator coil end 12a drawn out from a slot of the stator core 11 is connected to a phase ring 6 disposed in a circumferential direction, and via the phase ring 6, the stator coil end 12a is connected to another stator coil end 12a or a terminal 15.

The left part of FIG. 2A illustrates a case where the stator coil ends 12a are connected to each other, and the right part illustrates a case where the stator coil ends 12a are connected to the terminals 15.

FIG. 2B is a schematic cross-sectional view as seen in the direction A-A of FIG. 2A.

The phase ring 6 is disposed along the circumferential direction, and a plurality of conductors (three in this example) are arranged at predetermined intervals in an axial direction. The axial position and length are adjusted based on the connection point of the stator coil end 12a or the terminal 15.

A phase lead 16 is a member that absorbs displacement between the axial position of the tip of the stator coil end 12a and the axial position of the phase ring 6.

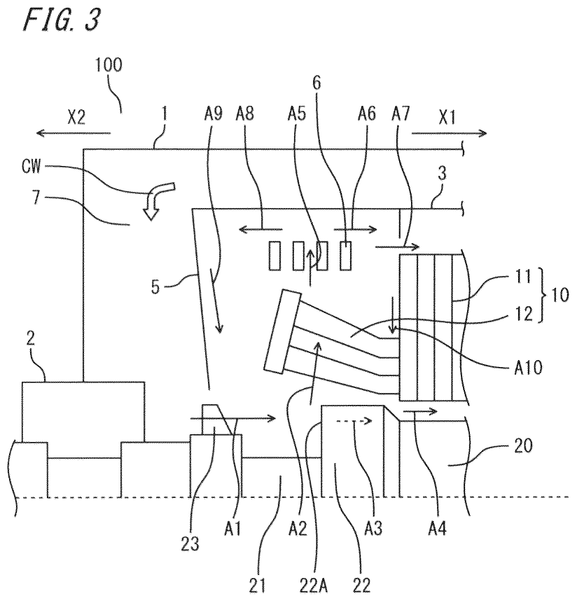

Next, with reference to FIG. 3, the main flow of cooling air for the stator coil end portion and the phase ring of the rotary electric machine will be described.

Cooling air CW flowing from the ventilation path 7 is sent toward the axial inner side X1 by the axial flow fan 23.

Cooling air A1 sent out from the axial flow fan 23 is divided into cooling air A3 and A4, and cooling air A2.

Cooling air A3 and A4 flows toward the rotor 10 side.

Cooling air A2 flows toward the stator coil end portion 12 after colliding with an axial outer end portion 22A of the holding ring 22 at the axial outer side X2.

Cooling air A3 cools the rotor coil held within the holding ring 22, and cooling air A4 flows into a space between the stator 10 and the rotor 20.

Cooling air A2 cools the stator coil end portion 12, and further becomes cooling air A5 that cools the phase ring 6.

A part of cooling air A5 proceeds toward the axial £ outer side X2, becomes cooling air A8 and A9, and merges with cooling air A1 and A2.

Another part of cooling air A5 proceeds toward the axial inner side X1 and becomes cooling air A6. A part of cooling air A6 further proceeds toward the axial inner side X1 and becomes cooling air A7 that flows into a space between the stator 10 and the stator frame 3.

Another part of cooling air A6 proceeds in the radial inner direction Y2, becomes cooling air 10, and merges with cooling air A4.

The present disclosure changes in:

a relationship between an outer diameter of the axial flow fan 23 and an outer diameter of an axial outer end portion 22A of the holding ring;

a relationship of an axial position of the axial outer end portion 22A of the holding ring; and a structure of the axial outer end portion 22A of the holding ring.

The present disclosure has an object of actively directing air to a portion where the temperature becomes high in the stator coil end portion 12 or the phase ring 6, by controlling flow paths of cooling air A2 and A5 by changing these above.

In the stator coil end portion 12 or the phase ring 6, since the magnetic flux linkage varies depending on the axial position, electrical loss varies accordingly, and a portion where the temperature becomes locally high arises.

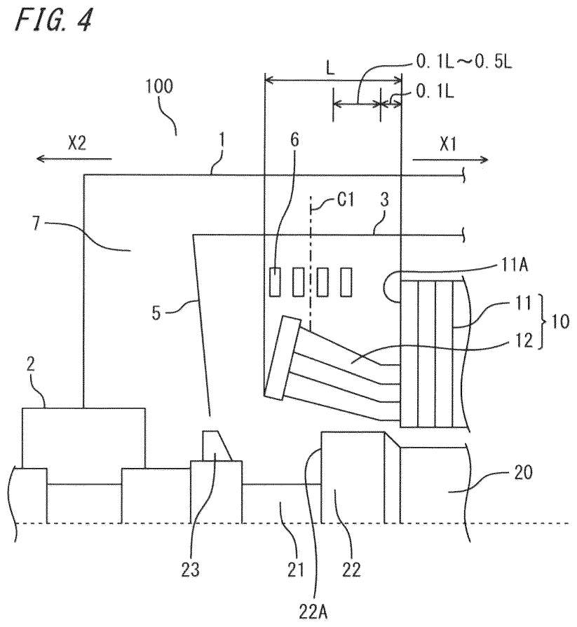

FIG. 4 is a diagram for explaining cooling positions of the stator coil end portion and the phase ring of the rotary electric machine.

In the stator coil end portion 12, when an axial length is defined as L, with an axial end portion 11A of the stator core 11 as a starting point and a tip on the axial outer side X2 of the stator coil end portion 12 as an endpoint, magnetic flux linkage increases at a position from 0.1 L to 0.5 L from the axial end portion 11A of the stator core 11 (the starting point), causing an increase in eddy current loss and temperature.

The phase ring 6 is composed of a sequence of conductors arranged in the axial direction. Since the conductors arranged on an axial central position C1 side are linked with more magnetic flux than those arranged on both axial end sides, eddy current loss becomes larger and temperature increases.

It is noted that the axial central position Cl of the phase ring 6 is located at a position from 0.6 L to 0.9 L from the axial end portion 11A (starting point) of the stator core 11.

Whether the cooling air is directed preferentially to the high temperature portion of the stator coil end portion 12 or the phase ring 6 varies depending on the design conditions of the rotating electric machine 100, etc.

### Example 1

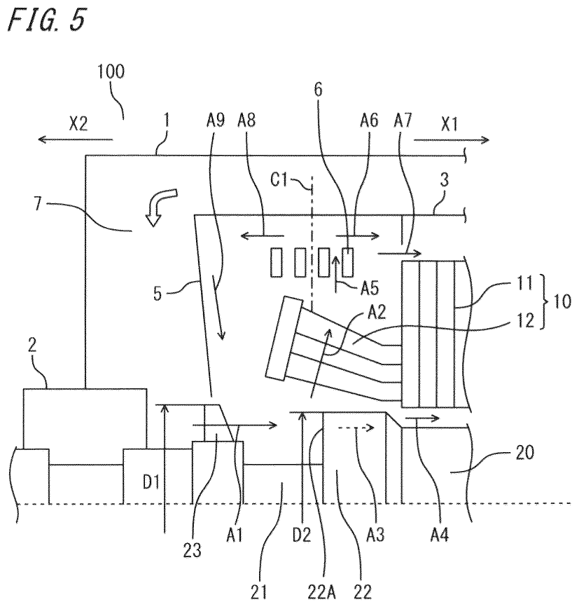

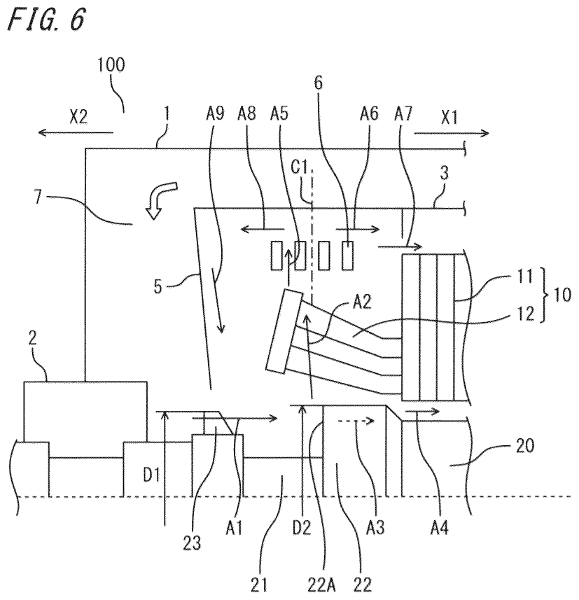

FIGS. 5 and 6 are partial cross-sectional views for explaining a method for manufacturing a rotary electric machine according to example 1 of the present disclosure.

First, as shown in FIG. 5, when cooling an axial inner side X1 of at least one of the stator coil end portion 12 and the phase ring 6, a relative ratio of an outer diameter D1 of the axial flow fan 23 to an outer diameter D2 of an axial outer end portion 22A of the holding ring is increased.

As a result, as shown in FIG. 5, cooling air Al blown from the axial flow fan 23 collides with the axial outer end portion 22A of the holding ring, becomes cooling air A2 that flows toward the stator coil end portion 12, and the cooling air A2 cools the stator coil end portion 12, and further becomes cooling air A5 that cools the phase ring 6.

In this case, since the relative ratio of the outer diameter D1 of the axial flow fan 23 to the outer diameter D2 of the axial outer end portion 22A of the holding ring is increased, the cooling air A2 cools the axial inner side X1 of the stator coil end portion 12, and the cooling air A5 cools the axial inner side X1 of the phase ring 6.

Next, as shown in FIG. 6, when cooling an axial outer side X2 of at least one of the stator coil end portion 12 and the phase ring 6, the relative ratio of an outer diameter D1 of the axial flow fan 23 to an outer diameter D2 of an axial outer end portion 22A of the holding ring is decreased.

As a result, as shown in FIG. 6, cooling air A1 blown from the axial flow fan 23 collides with the axial outer end portion 22A of the holding ring and becomes cooling air A2 that flows toward the stator coil end portion 12, and the cooling air A2 cools the stator coil end portion 12 and further becomes cooling air A5 that cools the phase ring 6.

In this case, since the relative ratio of the outer diameter D1 of the axial flow fan 23 to the outer diameter D2 of the axial outer end portion 22A of the holding ring is decreased, the cooling air A2 cools the axial outer side X2 of the stator coil end portion 12, and the cooling air A5 cools the axial outer side X2 of the phase ring 6.

As described above, according to the present example,
when cooling an axial inner side of at least one of the stator coil end portion 12 and the phase ring 6, a relative ratio of an outer diameter of the axial flow fan 23 to an outer diameter of an axial outer end portion 22A of the holding ring is increased, and
when cooling an axial outer side of at least one of the stator coil end portion 12 and the phase ring 6, the relative ratio of the outer diameter of the axial flow fan 23 to the outer diameter of the axial outer end portion 22A of the holding ring is decreased,
thereby allowing cooling air to be adjusted and guided to a desired position of at least one of the stator coil end portion 12 and the phase ring 6.

More specifically, as shown in FIG. 5, when cooling the axial inner side X1 of at least one of the stator coil end portion 12 and the phase ring 6, the ratio of the outer diameter D1 of the axial flow fan 23 to the outer diameter D2 of the axial outer end portion 22A of the holding ring is set to 1.0 or more, and as shown in FIG. 6, when cooling the axial outer side X2 of at least one of the stator coil end portion 12 and the phase ring 6, the ratio of the outer diameter D1 of the axial flow fan 23 to the outer diameter D2 of the axial outer end portion 22A of the holding ring is set to less than 0.9. By setting the ratio of the outer diameter D1 of the axial flow fan 23 to the outer diameter D2 of the axial outer end portion 22A of the holding ring to 1.0 or more, the flow paths of the cooling air A2 and A5 after colliding with the axial outer end portion 22A of the holding ring can be adjusted and guided from the axial central position C1 of the phase ring 6 to the axial inner side X1.

By setting the ratio of the outer diameter D1 of the axial flow fan 23 to the outer diameter D2 of the axial outer end portion 22A of the holding ring to less than 0.9, the flow paths of the cooling air A2 and A5 after colliding with the axial outer end portion 22A of the holding ring can be adjusted and guided from the axial central position C1 of the phase ring 6 to the axial outer side X2.

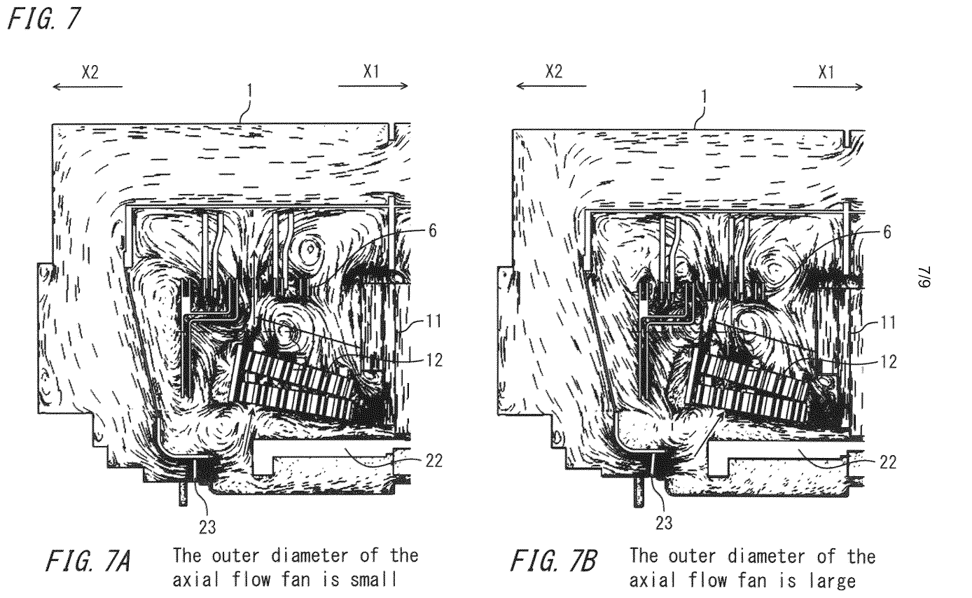

FIGS. 7A and 7B are diagrams in which the flow of cooling air around the stator coil end portion 12 and the phase ring 6 is analyzed by numerical calculation in a case where the outer diameter of the axial flow fan is relatively small and in a case where it is relatively large.

As shown in FIG. 7A, by decreasing the ratio of the outer diameter of the axial flow fan to the outer diameter of the axial outer end portion 22A of the holding ring, it is confirmed that the flow paths of the cooling air A2 and the cooling air A5 move to the axial outer side X2. By increasing the cooling air at any position on the axial outer side X2 of the stator coil end portion 12 and the phase ring 6, where electrical loss becomes large and temperature tends to rise, effective temperature reduction can be performed. This contributes to an improvement in the output density of the rotary electric machine.

On the other hand, as shown in FIG. 7B, by increasing the ratio of the outer diameter of the axial flow fan to the outer diameter of the axial outer end portion 22A of the holding ring, it is confirmed that the flow paths of the cooling air A2 and the cooling air A5 move to the axial inner side X1. By increasing the cooling air at any position on the axial inner side X1 of the stator coil end portion 12 and the phase ring 6, where electrical loss becomes large and temperature tends to rise, effective temperature reduction can be performed. This contributes to an improvement in the output density of the rotary electric machine.

### Example 2

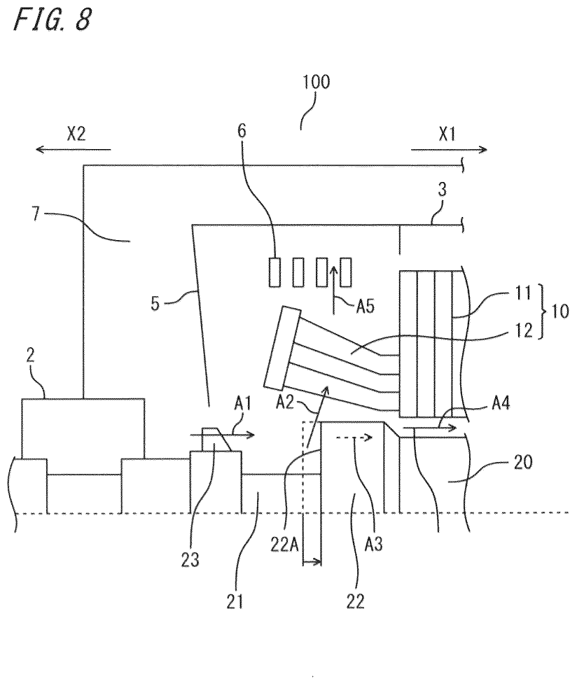

FIG. 8 is a partial cross-sectional view for explaining a method for manufacturing a rotary electric machine according to example 2 of the present disclosure.

In the method for manufacturing a rotary electric machine according to example 2,
when cooling an axial inner side X1 of at least one of the stator coil end portion 12 and the phase ring 6,
a position of an axial outer end portion 22A of the holding ring with respect to an axial position of the axial flow fan 23 is provided on the axial inner side X1 as shown by a solid line in FIG. 8, and
when cooling an axial outer side X2 of at least one of the stator coil end portion 12 and the phase ring 6, the position of the axial outer end portion 22A of the holding ring with respect to the axial position of the axial flow fan 23 is provided on the axial outer side X2 as shown by a broken line in FIG. 8.

That is, when cooling an axial inner side X1 of at least one of the stator coil end portion 12 and the phase ring 6,
by setting a position of an axial outer end portion 22A of the holding ring, with respect to an axial position of the axial flow fan 23, to the axial inner side X1,
while keeping a relationship of outer diameters between the axial flow fan 23 and the axial outer end portion 22A of the holding ring fixed,
flow paths of cooling air A2 and A5 after colliding with the axial outer end portion 22A of the holding ring can be adjusted and guided to the axial inner side X1.

On the other hand, when cooling an axial outer side X2 of at least one of the stator coil end portion 12 and the phase ring 6,
by setting a position of the axial outer end portion 22A of the holding ring, with respect to the axial position of the axial flow fan 23, to the axial outer side X2,
while keeping the relationship of outer diameters between the axial flow fan 23 and the axial outer end portion 22A of the holding ring fixed,
flow paths of cooling air A2 and A5 after colliding with the axial outer end portion 22A of the holding ring can be adjusted and guided to the axial outer side X2.

### Example 3

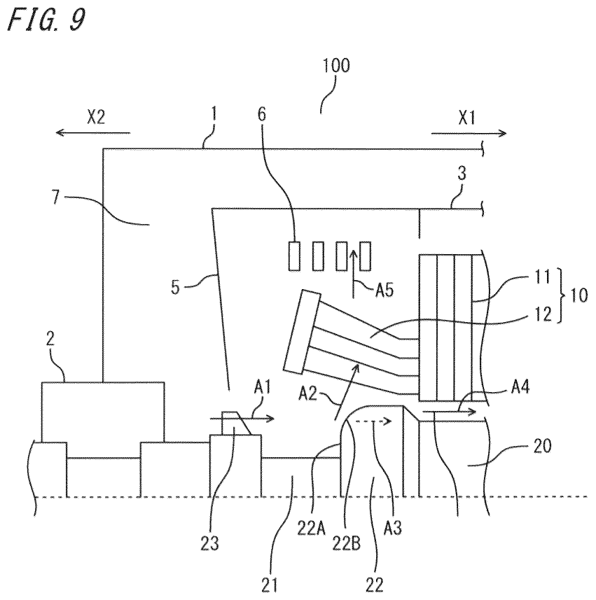

FIG. 9 is a partial cross-sectional view for explaining the method for manufacturing the rotary electric machine according to example 3 of the present disclosure.

In the method for manufacturing the rotary electric machine according to example 3 of the present disclosure, when cooling an axial inner side X1 of at least one of the stator coil end portion 12 and the phase ring 6, a corner portion 22B of an axial outer end portion 22A of the holding ring is chamfered.

That is, when cooling an axial inner side X1 of at least one of the stator coil end portion 12 and the phase ring 6, by chamfering the corner portion 22B of the axial outer end portion 22A of the holding ring,
while keeping a relationship of outer diameters between the axial flow fan 23 and the axial outer end portion 22A of the holding ring fixed,
flow paths of cooling air A2 and A5 after colliding with the axial outer end portion 22A of the holding ring can be adjusted and guided to the axial inner side X1.

### Example 4

In the method for manufacturing the rotary electric machine according to example 4 of the present disclosure,
a temperature distribution in the axial direction of at least one of the stator coil end portion 12 and the phase ring 6 is measured in advance by actual measurement or by simulation, and
based on the temperature distribution in the axial direction, the ratio of the outer diameter of the axial flow fan 23 to the outer diameter of an axial outer end portion 22A of the holding ring is adjusted.

Also, a position of the axial outer end portion 22A of the holding ring with respect to the axial position of the axial flow fan 23 may be adjusted.

Further, when cooling the axial inner side X1, the corner portion 22B of the axial outer end portion 22A of the holding ring may be chamfered.

### Effect of the Embodiment of the Present Disclosure

As described above, the method for manufacturing the rotary electric machine according to the embodiment of the present disclosure is the method for manufacturing the rotary electric machine, the rotary electric machine including:
a stator including a stator core, a stator coil provided in the stator core, and a stator coil end portion protruding from an axial end portion of the stator core;
a rotor including a rotor coil provided on a rotor shaft so as to face an inner peripheral portion of the stator core, and a holding ring that holds an axial end portion of the rotor coil;
an axial flow fan provided on an axial outer side of the holding ring on the rotor shaft; and
a phase ring provided on a radial outer side of the stator coil end portion and connected to the stator coil end portion.

The Method comprises:
increasing a relative ratio of an outer diameter of the axial flow fan to an outer diameter of an axial outer end portion of the holding ring, when cooling an axial inner side of at least one of the stator coil end portion and the phase ring; and
decreasing the relative ratio of the outer diameter of the axial flow fan to the outer diameter of the axial outer end portion of the holding ring, when cooling an axial outer side of at least one of the stator coil end portion and the phase ring.

According to this method, flow paths of cooling air flowing to the stator coil end portion or the phase ring of the rotary electric machine can be controlled, and
the air volume of the cooling air to a portion where electrical loss becomes large can be increased.

Also, when cooling the axial inner side of at least one of the stator coil end portion and the phase ring, the ratio of the outer diameter of the axial flow fan to the outer diameter of the axial outer end portion of the holding ring is set to 1.0 or more, and
when cooling the axial outer side of at least one of the stator coil end portion and the phase ring, the ratio of the outer diameter of the axial flow fan to the outer diameter of the axial outer end portion of the holding ring is set to less than 0.9,
so that the flow paths of the cooling air flowing to the stator coil end portion or the phase ring can be controlled more precisely, and
the air volume of the cooling air to a location where electrical loss becomes large can be increased.

Also, when cooling an axial inner side of at least one of the stator coil end portion and the phase ring, an axial outer end portion of the holding ring is disposed on an axial inner side with respect to an axial position of the axial flow fan, and
when cooling an axial outer side of at least one of the stator coil end portion and the phase ring, the axial outer end portion of the holding ring is disposed on an axial outer side with respect to the axial position of the axial flow fan,
so that the flow paths of the cooling air flowing to the stator coil end portion or the phase ring can be controlled more effectively, and
the air volume of the cooling air to a portion where electrical loss becomes large can be increased.

Also, when cooling an axial inner side of at least one of the stator coil end portion and the phase ring, a corner portion of the axial outer end portion of the holding ring is chamfered,
so that the flow paths of cooling air flowing to the stator coil end portion or the phase ring of the rotary electric machine can be controlled more effectively, and the air volume of the cooling air to a portion where electrical loss becomes large can be increased.

Also, a temperature distribution in the axial direction of at least one of the stator coil end portion and the phase ring is measured in advance, and
based on the temperature distribution in the axial direction, at least the ratio of the outer diameter of the axial flow fan to the outer diameter of the axial outer end portion of the holding ring is adjusted,
so that the flow paths of cooling air flowing to the stator coil end portion or the phase ring of the rotary electric machine can be controlled more precisely, and
the air volume of the cooling air to a portion where electrical loss becomes large can be increased.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 casing
6 phase ring
10 stator
11 stator core
12 stator coil end portion
20 rotor
21 rotor shaft
22 holding ring
22A axial outer end portion of holding ring
23 axial flow fan
100 rotary electric machine

1. A method for manufacturing a rotary electric machine, the rotary electric machine including:
a stator including a stator core, a stator coil provided in the stator core, and a stator coil end portion protruding from an axial end portion of the stator core;
a rotor including a rotor coil disposed on a rotor shaft so as to face an inner peripheral portion of the stator core, and a holding ring that holds an axial end portion of the rotor coil;
an axial flow fan provided on an axial outer side of the holding ring on the rotor shaft; and
a phase ring provided on a radial outer side of the stator coil end portion and connected to the stator coil end portion; wherein
the method comprises:
increasing a relative ratio of an outer diameter of the axial flow fan to an outer diameter of an axial outer end portion of the holding ring, when cooling an axial inner side of at least one of the stator coil end portion and the phase ring; and
decreasing the relative ratio of the outer diameter of the axial flow fan to the outer diameter of the axial outer end portion of the holding ring, when cooling an axial outer side of at least one of the stator coil end portion and the phase ring.

2. The method for manufacturing the rotary electric machine according to claim 1, wherein
when cooling the axial inner side of at least one of the stator coil end portion and the phase ring, the ratio of the outer diameter of the axial flow fan to the outer diameter of the axial outer end portion of the holding ring is set to 1.0 or more, and
when cooling the axial outer side of at least one of the stator coil end portion and the phase ring, the ratio of the outer diameter of the axial flow fan to the outer diameter of the axial outer end portion of the holding ring is set to less than 0.9.

3. The method for manufacturing a rotary electric machine according to claim 1, wherein
when cooling the axial inner side of at least one of the stator coil end portion and the phase ring, an axial outer end portion of the holding ring is disposed on an axial inner side with respect to an axial position of the axial flow fan, and
when cooling an axial outer side of at least one of the stator coil end portion and the phase ring, the axial outer end portion of the holding ring is disposed on an axial outer side with respect to the axial position of the axial flow fan.

4. The method for manufacturing the rotary electric machine according to claim 1, wherein
when cooling an axial inner side of at least one of the stator coil end portion and the phase ring, a corner portion of the axial outer end portion of the holding ring is chamfered.

5. The method for manufacturing the rotary electric machine according to claim 1, wherein
a temperature distribution in the axial direction of at least one of the stator coil end portion and the phase ring is previously measured, and
based on the temperature distribution in the axial direction, at least the ratio of the outer diameter of the axial flow fan to the outer diameter of the axial outer end portion of the holding ring is adjusted.

6. The method for manufacturing a rotary electric machine according to claim 2, wherein
when cooling the axial inner side of at least one of the stator coil end portion and the phase ring, an axial outer end portion of the holding ring is disposed on an axial inner side with respect to an axial position of the axial flow fan, and
when cooling an axial outer side of at least one of the stator coil end portion and the phase ring, the axial outer end portion of the holding ring is disposed on an axial outer side with respect to the axial position of the axial flow fan.

7. The method for manufacturing the rotary electric machine according to claim 2, wherein
when cooling an axial inner side of at least one of the stator coil end portion and the phase ring, a corner portion of the axial outer end portion of the holding ring is chamfered.

8. The method for manufacturing the rotary electric machine according to claim 3, wherein
when cooling an axial inner side of at least one of the stator coil end portion and the phase ring, a corner portion of the axial outer end portion of the holding ring is chamfered.

9. The method for manufacturing the rotary electric machine according to claim 6, wherein
when cooling an axial inner side of at least one of the stator coil end portion and the phase ring, a corner portion of the axial outer end portion of the holding ring is chamfered.

10. The method for manufacturing the rotary electric machine according to claim 2, wherein
a temperature distribution in the axial direction of at least one of the stator coil end portion and the phase ring is previously measured, and
based on the temperature distribution in the axial direction, at least the ratio of the outer diameter of the axial flow fan to the outer diameter of the axial outer end portion of the holding ring is adjusted.

11. The method for manufacturing the rotary electric machine according to claim 3, wherein
a temperature distribution in the axial direction of at least one of the stator coil end portion and the phase ring is previously measured, and
based on the temperature distribution in the axial direction, at least the ratio of the outer diameter of the axial flow fan to the outer diameter of the axial outer end portion of the holding ring is adjusted.

12. The method for manufacturing the rotary electric machine according to claim 4, wherein
a temperature distribution in the axial direction of at least one of the stator coil end portion and the phase ring is previously measured, and
based on the temperature distribution in the axial direction, at least the ratio of the outer diameter of the axial flow fan to the outer diameter of the axial outer end portion of the holding ring is adjusted.

13. The method for manufacturing the rotary electric machine according to claim 6, wherein
a temperature distribution in the axial direction of at least one of the stator coil end portion and the phase ring is previously measured, and
based on the temperature distribution in the axial direction, at least the ratio of the outer diameter of the axial flow fan to the outer diameter of the axial outer end portion of the holding ring is adjusted.

14. The method for manufacturing the rotary electric machine according to claim 7, wherein
a temperature distribution in the axial direction of at least one of the stator coil end portion and the phase ring is previously measured, and
based on the temperature distribution in the axial direction, at least the ratio of the outer diameter of the axial flow fan to the outer diameter of the axial outer end portion of the holding ring is adjusted.

15. The method for manufacturing the rotary electric machine according to claim 8, wherein
a temperature distribution in the axial direction of at least one of the stator coil end portion and the phase ring is previously measured, and
based on the temperature distribution in the axial direction, at least the ratio of the outer diameter of the axial flow fan to the outer diameter of the axial outer end portion of the holding ring is adjusted.

16. The method for manufacturing the rotary electric machine according to claim 9, wherein
a temperature distribution in the axial direction of at least one of the stator coil end portion and the phase ring is previously measured, and
based on the temperature distribution in the axial direction, at least the ratio of the outer diameter of the axial flow fan to the outer diameter of the axial outer end portion of the holding ring is adjusted.
